(19) United States
(12) Patent Application Publication
(10) Pub. No.: US 2005/0068177 A1
(43) Pub. Date: Mar. 31, 2005

(54) Security device for detecting change of air pressure and method thereof

(76) Inventors: Soon Yong Chun, Youngjoo-si (KR); Sung Soo Han, Gyungsan-si (KR)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 10/670,758

(22) Filed: Sep. 25, 2003

(51) Int. Cl. G08B 13/00

(52) U.S. Cl. 340/550; 340/545.2; 340/566

(57) ABSTRACT

A security alarm device of the present invention detects change of indoor pressure and converts the change to electric signals (more particularly, voltage signals) with a variety of frequencies by using a sensor unit installed therein, particularly sensing a low frequency that is generated when the door opens among other converted electric signals. Then, when the electric signals corresponding to the low frequency turned out to be caused by intrusion of the object from the outside, the device immediately sound an alarm to notify the intrusion to a user in a remote place. According to the security alarm device and the method thereof, the intrusion of the object from the outside is sensed as the electric signals of the low frequency, and notifies the intrusion to the user to alarm the security.

### BACKGROUND OF THE INVENTION

The present invention relates to a security alarm system. In particular, the present invention relates to a security alarm device for detecting to the change of pressure and method thereof, which is capable of detecting changes occur in an indoor, especially the change of air pressure caused by an intrusion of a foreign object and notifying the intrusion to a user immediately to allow the user to take a prompt action for the incident and thereby, providing a safer life with the user.

FIG. 1 is a schematic block diagram for explaining a configuration of an existing security alarm.

As shown in FIG. 1, a typical security alarm device includes a position sensor 11 for detecting any unexpected change in surroundings, an amplifier 12 for amplifying an electric signal detected through the position sensor 11, and an alarm means 13 for notifying a user regarding the change in surroundings in accordance with the signal amplified through the amplifier 12.

Referring to FIG. 1, the operation of the aforementioned security alarm system will now be described. The position sensor 11 that employs light, such as infrared rays, is installed in designated positions, and the sensor 11 detects a movement of an unidentified object as the object passes through the designated positions. The detected signal is amplified through the amplifier 12. The alarm means 13 is activated by the amplified signal or other designated alarm means is actuated by an external power supply.

However, the above-mentioned security alarm device can only detect the movement of the unidentified object within the detection boundary of the position sensor in the designated region. Therefore, in order to cover more areas, a plurality of position sensors have to be affixed at different places, costing a considerable amount of money in installing the system.

Furthermore, once the device is installed, it is very difficult to move from its initial position which makes inconvenient for the user use the system.

As mentioned before, only when the outside object enters the detection area of the position sensor 11, the alarm may be sounded upon identifying the object. Hence, it is inevitable for the user to install many security alarm devices as require to cover the intended area to secure safety.

The security alarm system applying the position sensor in the related art has another problem that it sounds alarm against anyone within the detection limit although that might be the owner of the house.

### SUMMARY OF THE INVENTION

It is, therefore, an object of the present invention to provide a security alarm device for responding change of pressure and method thereof, which responds to change of indoor pressure that is often generated at home.

To achieve the above object, there is provided a security alarm device, comprising a sensor unit for electrically detecting the change of indoor pressure generated by the intrusion of an object from the outside; an amplifying unit for amplifying the electric signal corresponding to the change of indoor pressure detected by the sensor unit; an one-chip processor for deciding whether or not the electric signal transmitted from the amplifying unit is caused by the intrusion of the object from the outside; a switching unit for adjusting the operational state of the one-chip processor; and an alarm unit for notifying the intrusion of the object to a user in case that the one-chip processor decides that the change of pressure is caused by the intrusion of the object from the outside.

Preferably, a condenser microphone is used for the sensor unit. Also, the one-chip processor preferably includes a low-pass filter that passes a low frequency signal only, similar to the case of opening the door in response to the signal passed through the amplifying unit.

Another embodiment of the present invention provides a security alarm device, comprising: a sensor unit for electrically detecting change of indoor pressure as the door opens; an amplifying unit for amplifying the electric signal corresponding to the change of indoor pressure detected by the sensor unit; a low-pass filter for passing a low electric signal only that is similar to the low frequency electric signal among other electric signals passed through the amplifying unit, being generated by change of indoor pressure as the door opens; an one-chip process for deciding whether or not the low frequency electric signal transmitted from the amplifying unit is the low frequency signal caused by opening the door; a switching unit for adjusting the operational state of the one-chip processor; and an alarm unit for notifying the intrusion of the object to a user in case that the one-chip processor decides that the low frequency signal is caused by the intrusion of the object from the outside; and a transmission unit for notifying the intrusion to the user via the wire and/or wireless telephone if the one-chip processor confirms that the low frequency signal is caused by the intrusion of the object from the outside.

Preferably, the one-chip processor includes a digital frequency filter for passing only similar frequencies to the frequency generated by opening the door more accurately among other low frequency electric signals that passed through the low-pass filter.

More preferably, the one-chip processor includes a digital noise filter for generating an on/off signal that makes the low frequency included in heavy noise to be properly ignored, being formed on a branched line after the amplifying unit.

Another aspect of the present invention provides a method of the security alarm, comprising the steps of: detecting change of indoor pressure through an electric signal of the sensor unit; converting the electric signal detected by the sensor unit to an amplified analog signal; a low-pass filtering the amplified analog signals by a low bandwidth; converting the low-pass analog signals to digitalized sampling values by sampling the analog signals periodically; and sounding alarm or warning the user in a remote place through the wire and/or wireless telephone if smaller sampling values than the reference are inputted for a certain period.

Preferably, the user can optionally designate the reference, or a minimum value in at least two sampling values inputted in an early stage of the alarming step can be the reference.

In addition, it is preferable to include a step of band-pass filtering for passing a number of frequencies generated by opening the door immediately after the low-pass filtering step. Preferably, the band-pass filtering passes frequencies to a broad range, such as 4-12 Hz and/or 14-25 Hz.

On the other hand, the alarming step preferably includes a further step of filtering digital noise in order to make the electric signals at low frequencies in a heavy noise to be ignored by making the on signal for selecting analog signals whose maximum value is smaller than the reference for a certain interval among the waveforms in a period of the analog signals outputted in the step of conversion.

### BRIEF DESCRIPTION OF THE DRAWINGS

The above objects, features and advantages of the present invention will become more apparent from the following detailed description when taken in conjunction with the accompanying drawings, in which:

FIG. 1 is a schematic diagram explaining the components of the security alarm device in accordance with the related art.

FIG. 2 is a pictorial diagram showing the component of the security alarm device that responds to the change of pressure in accordance with a first preferred embodiment of the present invention.

FIG. 3 is a detailed functional diagram showing details of the one-chip processor and adjacent circuit components of FIG. 2.

FIG. 4 is a flow chart explaining operational steps of the security alarm method for responding to the change of pressure in accordance with the present invention.

FIG. 5 is a detailed flow chart showing details of the steps of deciding whether or not the alarm is to be sounded and making the alarm signal of FIG. 4.

FIG. 6 is a flow chart explaining the steps of security alarm method in accordance with another preferred embodiment of the present invention.

FIG. 7 is a detailed flow chart showing details of the steps of designating a reference in accordance with still another preferred embodiment of the present invention.

FIG. 8 is a schematic diagram explaining the security alarm device in accordance with a second preferred embodiment of the present invention.

FIG. 9 is a schematic diagram showing the security alarm device in accordance with a third preferred embodiment of the present invention.

FIGS. 10A and 10B are exemplary diagrams showing waveforms that are inputted to the digital noise filter of FIG. 9.

FIG. 11 is an explanatory diagram of the security alarm device in accordance with a fourth preferred embodiment of the present invention.

FIG. 12 is an explanatory diagram of the security alarm device in accordance with another preferred embodiment of FIG. 11.

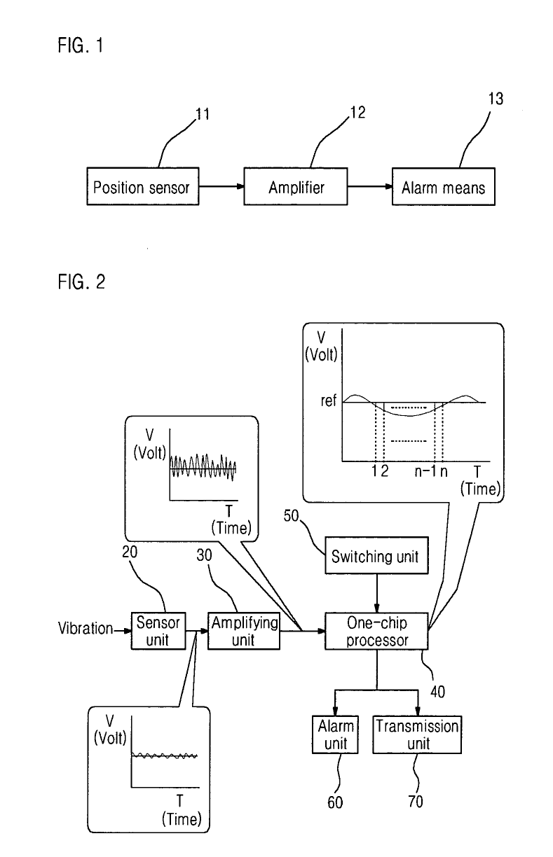

### DETAILED DESCRIPTION OF THE INVENTION

A preferred embodiment of the present invention will now be described with reference to the accompanying drawings.

While the invention shows and describe with reference to certain preferred embodiments thereof, it will be understood by those skilled in the art that various changes in form and details may be made therein without departing from the spirit and scope of the invention as defined by the appended claims. Also, well-known functions or constructions are not described in detail since they would obscure the invention in unnecessary detail.

FIG. 2 is a pictorial diagram showing the component of the security alarm device that configured to responds to the change of pressure in accordance with a first preferred embodiment of the present invention.

Referring to FIG. 2, the security alarm device of the present invention comprises: a sensor unit 20 for detecting a waveform according to the change of pressure transmitted through a designated medium and converting the waveform to an electric signal (preferably, a voltage signal); an amplifying unit 30 for amplifying the electric signal according to the change of pressure detected by the sensor unit 20; an one-chip processor 40 for separating a noise signal from the electrical signals that has been passed through the amplifying unit 30 and at the same time, detecting the change of pressure of a low-frequency signal only that is generated by the intrusion of an object from the outside; a switching unit 50 for adjusting a control mode that controls the operation of the one-chip processor 40 by the user; an alarm unit 60 for making an alarm signal being operated by the one-chip processor 40 which is checked by the user; and a transmission unit 70 for notifying the intrusion of the object from the outside to the user even in a remote place through the wire and/or wireless telephone.

In more detail, the switching unit 50 controls the sensitivity adjustment in order to make the one-chip processor 40 operates to recognize the intrusion of the object from the outside whenever there is any change of pressure to a certain degree, or provide a command to sound the alarm in a way of light or sound, or to the transmission unit 70.

Preferably the sensor unit 20 is formed by a condenser microphone that generates different voltages at the both electrodes of the condenser in accordance with a displacement from the stop position of a vibratile membrane, and senses a particular frequency that is transmitted by the change of pressure in a medium through change of voltage. More preferably, the sensor unit 20 should be able to adjust the sensitivity through hardware by utilizing a variable resistance when adjusting the voltage generated by the condenser microphone.

Preferably, the amplifying unit 30 employs a plurality of OP-Amps for amplifying the electric signals.

The amplifying unit 30 includes a battery sense circuit for sensing the voltage of the battery using the OP-Amp. Thus, the state of the battery sensed by the amplifying unit is transmitted to the one-chip processor 40.

The one-chip processor 40 is equipped with a self-memory and A/D (analog/digital) converter. It is recommended to use PIC16C711 of Microchip Company which utilizes an 8-bit processor or PIC16C770 of Microchip Company which uses a 12 bit processor as the one-chip processor since they are small in size, light weight and low-price.

As for the alarm unit 60, a variety of alarm means can be used, such as buzzers or lamps.

Preferably, the transmission unit 70 should include a wire and/or a wireless transmission unit including a high-frequency unit (RF unit) in order to notify the intrusion of the outside object to the user on a realtime mode even when the user is in a remote place.

In connection with the waveform, the sensor unit 20 converts the signals transmitted by a medium (especially, air) to the electric signals (preferably, voltage signals), and the amplifying unit 30 amplifies the electric signals in order to make more an accurate decision regards to the signals. The waveforms outputted from the sensor unit 20 and the waveforms outputted from the amplifying unit 30 are illustrated in a corresponding figure.

The detection procedure carried out in the one-chip processor 40 is explained hereinafter.

The one-chip processor 40 includes the designated low-pass filter unit that selectively allows frequency signals (hereinafter, it is abbreviated as frequency) having a particular low frequency generated when the door opens to pass through. The low frequency that passed through the low-pass filter unit goes through the sampling process. If the sampling value consecutively falls below the reference value, then its frequency is counted, and based on those counts, the frequency of the inputted low frequency is verified. If the inputted low frequency is recognized as the low frequency generated when the door is opened, then the alarm signal is sounded.

The sampling procedure in the one-chip processor 40 for detecting any change of pressure of the low frequency after filtering the noise signals is also illustrated in a corresponding figure.

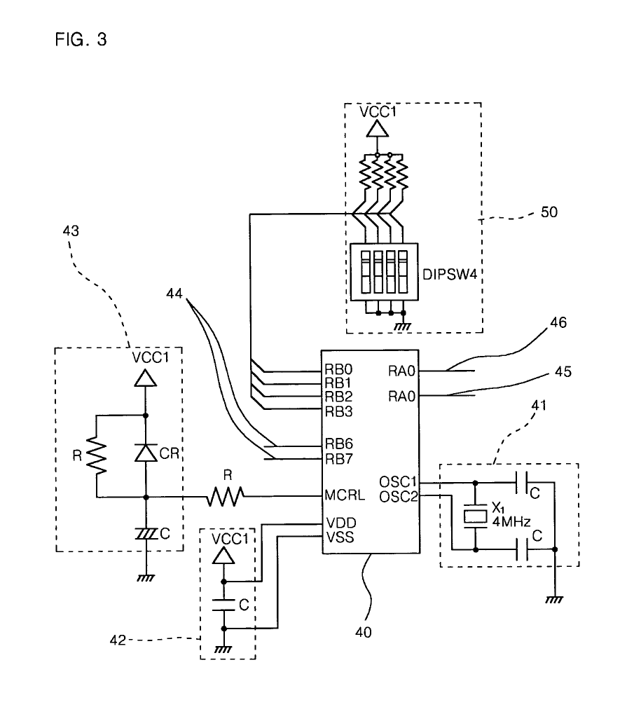

FIG. 3A is a diagram for explaining the security alarm device that responds to the change of pressure in accordance with the present invention.

Referring to FIG. 3, the one-chip processor 40 is formed with a driving circuit for driving the chip and a signal line for the external signals to be entered. More specifically, the driving circuit of the one-chip processor 40 includes an oscillating circuit unit 41 for generating a clock, a power voltage unit 42 for applying power to the chip, a reset unit 43 for resetting the operation of the chip, and a switching unit 50 is displayed for setting the operation mode for the one-chip processor 40. Further, the one-chip processor 40 includes the alarm line 44 connected to the alarm unit (see Reference 60 in FIG. 2) and/or the transmission unit (see Reference 70 in FIG. 2) for transmitting the alarm in a form of sound or light, or a wire/wireless transmission in accordance with the control under the one-chip processor 40, the signal sense line 45 for receiving the signal from the amplifying unit (see Reference 30 in FIG. 2), and the battery sense line 46 for sensing the state of the battery.

In addition, the one-chip processor 40 is equipped with the designated low-pass filter unit for selectively filtering out other noise generated when the door is opened and only allowing the low frequency signals that include a particular low frequency to be applied to the signal sense.

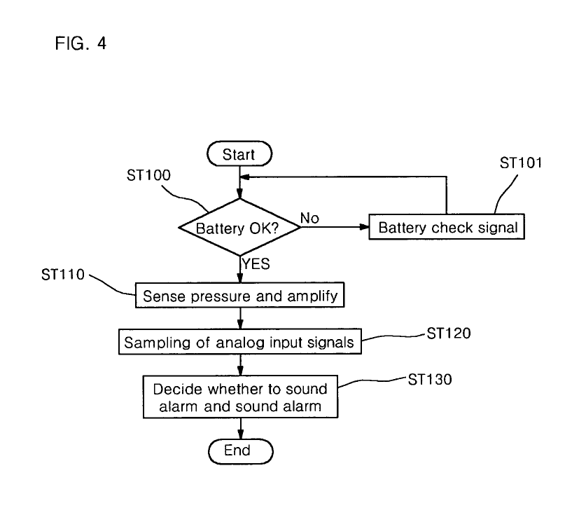

FIG. 4 is a flow chart explaining operational steps of the security alarm method for responding to the change of pressure in accordance with the present invention.

As shown in FIG. 4, when the security alarm device for responding to the change of pressure according to the present invention is actuated, the battery sense circuit (not shown) and the battery sense line 45 installed in the amplifying unit (see Reference 30 in FIG. 2) checks the state of the battery to make sure the battery is properly operating (ST 100).

If the battery does not properly operate, then the check signal of the battery is notified to the user by a designated means like the buzzer or the lamp (ST 101). The reason for providing the check signal of the battery is to make sure that the security alarm system works properly work even at the absence of the user.

After it is confirmed that the battery is in a normal state, the sensor unit (see Reference 20 in FIG. 2) and the amplifying unit (see Reference 30 in FIG. 2) detect any changes to the indoor pressure and amplifies the corresponding electric signal (preferably, the voltage signal). Then, the amplified signal is transmitted through the signal sense line 45 of the one-chip processor (see Reference 40 in FIG. 3) (ST 110).

Usually, the aforementioned electric signal is an analog signal. The designated low-pass filter placed in the inside of the one-chip processor 40 filters out the high-frequency electric signals that are considered as outside noises other than those generated when opening the door so that the analog signals of the low-band frequency including the low-frequency signals that are created when the door is opened. Thereafter, the low-frequency analog signals go through the sampling process and are converted to the appropriate forms for checking the input of the low-frequency signals (ST 120).

More specifically on the sampling step of the analog input signals (ST 120), after the analog signals are inputted into the one-chip processor 40, only the frequencies of the low-band can pass through in order to allow only the low frequencies that are generated when the door opens to be processed. Thus, the low-frequency analog signals are generated and thereafter, analog signals of the low-band are sampled to be ready for the digital process.

After the sampling step of the analog input signals is conducted, it is determined how long the sampled signals, particularly the sampled signals with the values lower than the reference value, continue to be transmitted to judge whether there has been any intrusion of the object from the outside. More specifically, in case that the sampling values that are greater or lower than the reference value are detected continuously, then they are determined as the low-frequency signals indicating that the door has been opened. If necessary, the user can change the reference value according to specified operating conditions of the system itself.

As mentioned above, the sampling values can be used to identify the intrusion of the object from the outside, because when the door opens by the unknown object, the electric signals greater or lower than the low reference are continuously inputted for a certain period of time due to the low-frequency characteristics.

When it is determined that the door has been opened by the unknown object from the outside, the security alarm device either sounds the alarm or immediately notifies the intrusion to the user to allow the user take the appropriate actions (ST 130).

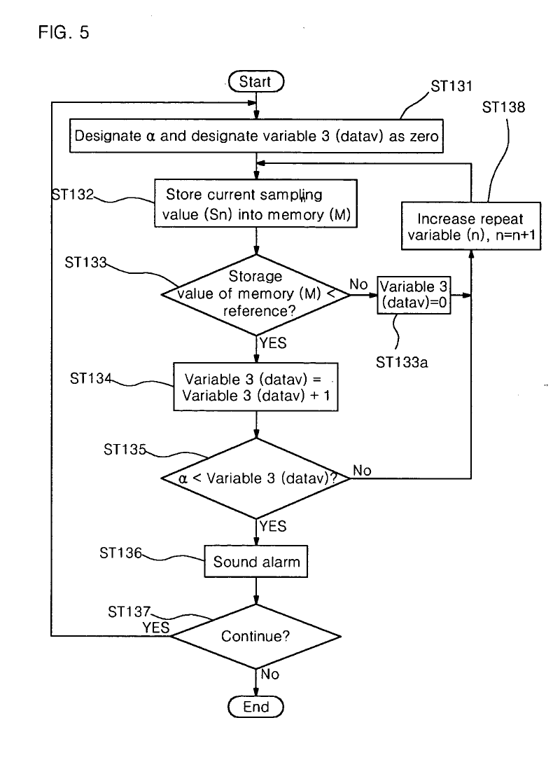

FIG. 5 is a detailed flow chart showing details of the steps of deciding whether or not the alarm is to be sounded and making the alarm signal of FIG. 4.

Referring to FIG. 5, a variable 3 (datav) necessary for the parameter is designated as zero, and α for deciding whether the door is opened when the signals with greater or lower than the reference continue for a while is designated (ST 131). In other words, the variable 3 (datav) means the sampling frequency, and α represents a threshold of the repeat frequency of the low-frequency sampling values to determine whether the door is opened or not.

In addition, the α can be controlled by the switching unit (see Reference 50 in FIG. 2), and the user also can adjust the sensitivity of the same, whenever necessary.

When all variables are properly inputted, the current sampling value (Sn) is read and is stored in the memory (M) (ST 132).

Then, the current sampling value (Sn) stored in the memory (M) and the reference are compared to each other (ST 133). As mentioned before, the user has an option to change the reference value if necessary.

If the reference value is greater than the current sampling value (Sn), then the current sampling value (Sn) is discarded and by designating the variable 3 (datav) as zero, it is recognized whether the sampling value below the reference value repeatedly occurs (ST 133a). Then, the repeat variable (n) only is allowed to increase by 1 (ST 138), and the next current sampling value (Sn) is read (ST 132).

In other words, a current sampling value, if it is not recognized to be the intrusion of the object from the outside, is discarded, and another sampling value that can be recognized as the low frequency is newly counted.

However, if the sampling value (Sn) stored in the memory (M) is smaller than the standard variable value, the variable 3 (datav) is increased by 1 (ST 134).

That is, the repeat frequency of the sampling value below the reference is stored in the variable 3 (datav).

After taking measures of increasing the variable 3 (datav) by 1 because of the current sampling value (Sn) lower than the reference value, it is decided whether the variable 3 (datav) is larger or smaller than α (ST135).

More specifically, if the variable 3 (datav) is same or greater than α, then the frequency of the sampling (that is, the wavelength of the low frequency) is considered to be the same or at least similar to the wavelength generated by opening the door. If not, the security alarm system determines that the frequency is not adequate enough to sound the alarm, and confirms that it is generated from the outside or due to other noises within the system itself, thereby passing over the current sampling value (Sn), and receives the next current sampling value (Sn) (ST 138).

Repeating the procedure described above, in case where the variable 3 (datav) exceeds αat the end, and the security alarm system of the present invention recognizes the increased variable 3 (datav) as decrease in the pressure caused by the intrusion of the object from the outside or opening the door, then the system sounds the alarm. Thereafter, the user discovers that there is the intrusion of the object from the outside and takes a proper action for the intrusion (ST 136).

Once the alarm is initiated, next step is to decide whether the security alarm device of the present invention should continue to operate. If it is necessary to continue the operation of the security alarm device, a new operation is proceeded by carrying out feedback of the designating step of the variable 3 (datav) (ST 141), and if not, the control method of the present invention is completed at this point (ST 137).

Explanation for how the system operates during the steps of deciding whether to sound the alarm and the procedure for sounding the alarm (ST 130) is illustrated hereinafter. The low frequencies generated by opening the door together with the high frequencies generated by outer noises goes through the sensor unit (see Reference 20 in FIG. 2) and the amplifying unit (see Reference 30 in FIG. 2) and is inputted into the one-chip processor (see Reference 40 in FIG. 2). Then, the one-chip processor 40 filters the low frequencies only among other low-frequency signals and high-frequency signals inputted thereto.

In addition, following the sampling process of the low frequencies, if the sampling values below the reference values are continuously inputted at a certain frequency, the sampling values are recognized to be identical with the frequency generated by opening the door, and the security alarm device sounds the alarm.

In contrast to the case above, in which the security alarm device sounds the alarm when it recognizes the sampling values below the reference value that are continued for a certain period of time as the low frequency, and it is also possible set up the system in accordance with the present invention such that if the sampling values greater than the reference continued for a certain period of time, they can be regarded as the low frequency generated by opening of the door.

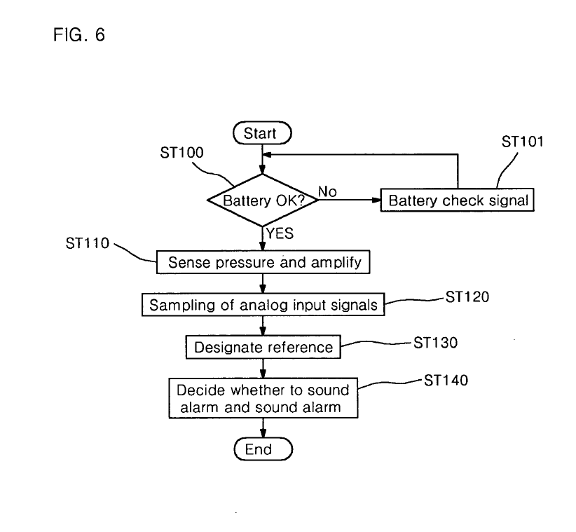

FIG. 6 is a flow chart explaining the steps of security alarm method in accordance with another preferred embodiment of the present invention.

With reference to FIG. 6, the reference can be changed in accordance with the surroundings in order to improve reliability of the device for sounding the alarm. The steps illustrated in FIG. 6 are basically identical with those of FIG. 4 except that a step of designating the reference is further added.

In more detail, the present embodiment further includes the steps of sampling the analog input signals (ST 120) and deciding whether to initiate the alarming component and sound the alarm (ST 130). To accomplish such, the one-chip processor (see Reference 40 in FIG. 2), at the time of initiating the operation of the security alarm device, measures the noises around the device for a while, not for sounding the alarm but for designating the minimum value out of the other frequencies in the noises as the reference.

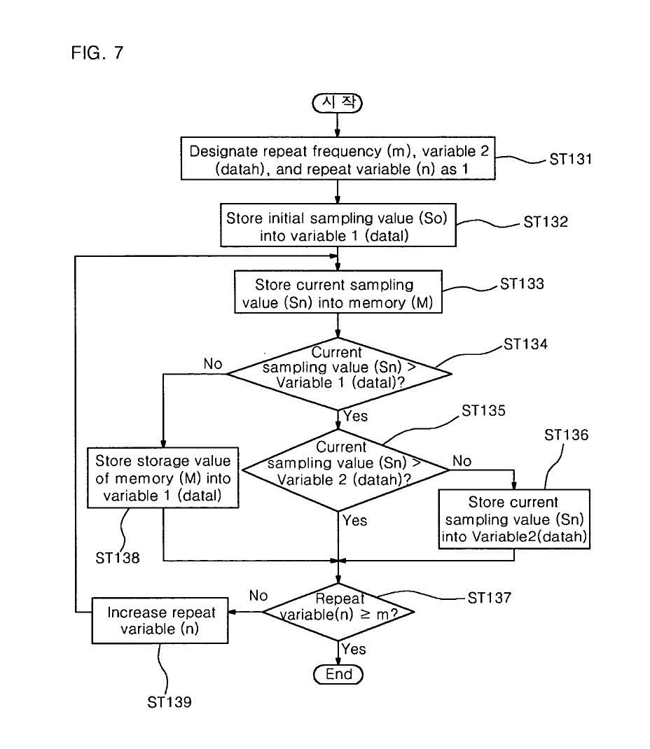

FIG. 7 is a detailed flow chart showing details of the steps of designating a reference in accordance with still another preferred embodiment of the present invention.

Referring to FIG. 7, according to another aspect of the present invention, the security alarm devices receives the signal via the one-chip processor (see Reference 40 in FIG. 2) through the same procedure carried out in the original embodiment, and then samples the low frequencies only. Then, among the low frequencies inputted as the outer noises, the minimum value thereof is designated as the reference value. At this point, the inputted signal is the signal inputted when the door is yet to be opened, having the assumption that the security alarm device of the present invention inputs the noises from the outside only. Such assumption does not have any influence on the effect of the device according to the present invention because it can be made in no time, supposing that the noises include the sound signal.

With reference to the same figure, the procedure of designating the reference is more explicitly explained as follows.

First, in order to designate the reference, the minimum numbers of the sampling required, that is, the repeat frequency (m), the variable 2 (datah), the repeat variable (n), and the repeat frequency (m) should be pre-designated, respectively. Then, the current sampling values (Sn) are continuously read. And, a plurality of the current sampling values (Sn), which have been read, go through a serious of procedures to designate the minimum current sampling value. Lastly, the repeat frequency (m) selects a single current sampling value (Sn), which consequently becomes the reference value.

More specifically, in order to designate the minimum value among other sampled signals inputted upon the operation of the security alarm device as the reference value, a plurality of variables should be designated first. Such variables include the repeat frequency (m), the variable 2 (datah), and the repeat variable (n), which are absolutely necessary to duly designate the minimum value. More preferably, the repeat frequency (m) should have the minimum value 2 or over in order to improve the reliability in designating the reference value. In addition, the initial value of the repeat variable (n) should take 1 (ST 131). However, it should be noted that these designated values could be changed any time according to the situations of the user. The details on the variable 2 (datah) and the repeat variable (n) will be followed later.

After designating the variables aforementioned, the start sampling value (So) is stored in the variable 1 (dahal) (ST 132), and the current sampling value (Sn) is stored in the memory (M) (ST 133). Although the start sampling value (So) can be pre-designated as the reference value, it is more preferable to designate zero as the reference value.

Once the variable are all designated and the current sampling value is well accepted following the procedures described above, the storage value of the variable 1 (datal) and the current sampling value (Sn) stored in the memory (M) are compared with each other, and the next step is initiated (ST 134).

Going through the comparison step of the current sampling value (Sn) and the starting sampling value (So) (ST 134), if the current sampling value (Sn) is greater than the starting sampling value (So), the current sampling value (Sn) is compared with the variable 2 (datah) again (ST 135).

In case that the storage value of the variable 2 (datah) is greater than the current sampling value (Sn), the storage value of the variable 2 (datah) is replaced with the current sampling value (Sn) (ST 136). In the next step, the repeat variable (n) and the initially designated repeat frequency (m) are compared with each other. If the repeat variable (n) is the same or over the repeat frequency (m), the current storage value of the variable 1 (datal) is regarded as the minimum value, which consequently becomes the reference value (ST 130), completing the step of designating the reference value.

If not, that is, if the storage value of the variable 2 (datah) is not greater than the current sampling value (Sn), then the step of inputting the current sampling value (Sn) (ST 133) is given a feedback for applying the current sampling value to the step of designating the reference value (ST 137). However, if the current sampling value (Sn) is not greater than the variable 2 (datah), meaning that the current sampling value (Sn) takes a value between the variable 1 (datah) and the variable 1 (datal), the current sampling value (Sn) is discarded. And, the repeat variable (n) and the original repeat frequency (m) are compared to each other (ST 137).

In the meantime, if the feedback is given to the repeat variable (n) because it being smaller than the repeat frequency (m), the repeat variable (n) sequentially increases by 1 until it becomes equal or greater than the designated repeat frequency (m) (ST 139). After the feedback, the new current sampling value (Sn) corresponding to the new repeat variable (n) is stored in the memory (M) (ST 133).

Meanwhile, if the current sampling value (Sn) turns out to be smaller or equal to the variable 1 (datal) in the step of comparing the current sampling value (Sn) and the variable 1 (datal), the storage value of the memory (M) is stored as the variable 1 (datal) (ST 138). While comparing the repeat variable (n) to the repeat frequency (m) (ST 137), it is judged whether the repeat frequency (m) has reached close to be appropriate as the reference value (ST 139).

After going through the steps illustrated in FIG. 7, the reference value becomes the variable 1 (datal) among other various variables suggested in the figure. Here, the variable 1 (datal) is the smallest sampling value collected from the sampling procedure, and the value is an essential factor in the step of deciding whether to sound the alarm and in the step of sounding the alarm (see Reference ST 140 in FIG. 6).

Although the minimum value among others in FIG. 7 was chosen to be the reference value in the present invention, the maximum value can be used for the same purpose also.

In the present invention, the smallest value was designated as the new reference as described above. According to the present invention, the reference changes itself through the repeat study function, depending on the surroundings, and a plurality of sampling values are tested to select the minimum value with the best or proper state for the new standard value.

By changing the reference value from time to time, the security alarm device of the present invention can recognize only the values lower than the typical noises as the low frequency generated by opening the door, which consequently gives better results.

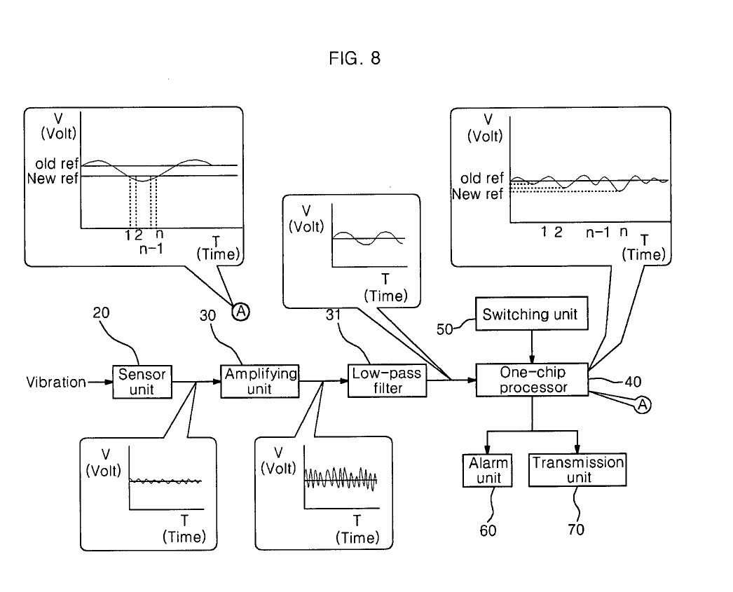

FIG. 8 is a schematic diagram explaining the security alarm device in accordance with a second preferred embodiment of the present invention.

As shown in FIG. 8, the low-pass filter unit inside of the one-chip processor 40 is separated from the filter and is physically installed at the outside of the one-chip processor 40. Similar to FIG. 2, the low-pass filter 31 for filtering the high-frequency signals including the signals like noises among the electric signals that passed through the amplifying unit 30 is installed. Also, the possible waveforms after the signals go through each component are additionally illustrated.

Especially, the waveform shown in one side of the one-chip processor 40 explaining the step of designating the reference is similar to that of in FIGS. 6 and 7 before. That is, it explains the procedure of designating the new reference against the old reference. And, the lower portion of FIG. 8 shows that the amplitudes and low-frequency signals that are smaller than the new reference are continually sampled for a certain period of time, and the security alarm device recognizes the signals as the low-frequency signals generated by opening the door.

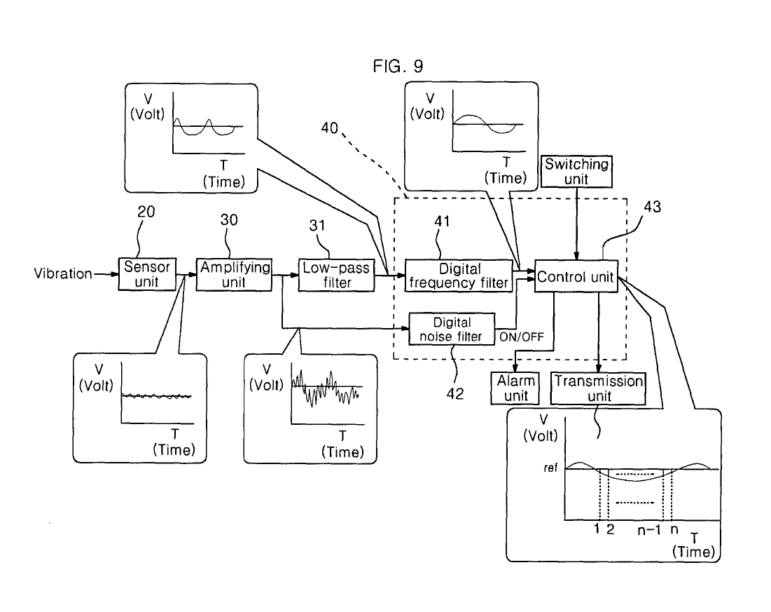

FIG. 9 is a schematic diagram showing the security alarm device in accordance with a third preferred embodiment of the present invention.

Referring to FIG. 9, the one-chip processor according to another embodiment of the present invention includes a digital frequency filter 41, a kind of band-pass filters for passing only the frequencies similar to the frequency generated by opening the door. Also, the processor further includes a digital noise filter 42 for outputting the signal not to sound the alarm by recognizing the frequencies including both low frequencies similar to the frequency generated by opening the door and a plurality of high frequencies as noises that are normally inputted from the outside.

More specifically speaking on the operation of the digital frequency filter 41, in consideration of the fact that especially 1˜30 Hz frequencies are generated when the door opens, the digital frequency filter 41 shuts off all waveform except for the frequency generated by opening the door, thereby raising reliability of the operation of the security alarm device.

More preferably, the frequencies with 4˜12 Hz or 14˜25 Hz among other low frequencies generated by opening the door can be passed through and all other low frequencies are shut off.

On the other hand, in more detail on the operation of the digital noise filter 42, the filter is very useful for the alarm devices installed in the places with a lot of noises, for example, nearby construction work places or the streets, and raises the reliability of the operation greatly.

In general, the amplitude of the frequency corresponding to the center of the noise gets larger as the degree of the noise gets larger. Similarly, the waveforms of the low frequencies similar to the frequency generated by opening the door get larger to a great extent.

Therefore, in order to maximize the performance of the security alarm device of the present invention even in the places with heavy noises, the device should be able to recognize the waveform generated by the noises as just regular noises and does not sound the alarm accordingly.

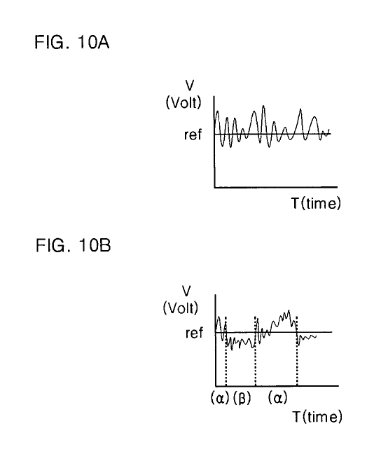

FIGS. 10A and 10B shows exemplary diagrams for explaining waveforms that are inputted to the digital noise filter of FIG. 9. Particularly, FIG. 10A is a diagram showing the waveform from the case in which only heavy noises other than ones created when the door is opened are inputted. On the other hand, FIG. 10B is a diagram showing the waveform of the instance in which the low frequency generated by opening the door is mixed with heavy surrounding noises from the location of the device are inputted.

Referring to FIG. 10A, although the waveform includes the signals of the heavy noises with the low-frequency component, the low frequency does not necessarily generate as large amplitude as that of opening the door. Therefore, the waveform continuously vibrates around the reference value. In contrast, the waveform of FIG. 10B includes the low frequency included in the heavy noise signals and the low frequency with a large wavelength generated by opening the door.

More specifically, FIG. 10B includes (α) interval, where the maximum value generated by the small noise waveform exceeds the reference value, and (β) interval, where the maximum value of the small noise waveform does not exceed the reference value (V1). Thus, when the inputted waveform has both (α) interval and (β) interval alternately, it means that the waveform includes the same low-frequency signal with the frequency generated as the door opens.

To summarize, when the waveform in FIG. 10A type is inputted to the digital noise filter 42, despite of that an appropriate signal for the waveform generated by opening the door is inputted to the digital frequency filter 41, the control unit 43 makes the off signal to prevent the device from recognizing the waveform as the signal generated by opening the door.

However, if the waveform in FIG. 10B type is inputted to the digital noise filter 42, the control unit 43 generates an ON signal in order to make the device recognize the waveform as the signal generated by opening the door.

Explaining again, the procedures described above is basically similar to the step of judging whether to sound the alarm and the step of sounding the alarm (ST 130) suggested in FIG. 4, only including an additional step of digital noise filtering process. Besides, the same procedures is again pretty similar to the step of deciding whether to sound the alarm and the step of sounding the alarm (ST 140) suggested in FIG. 6, only including a further step of digital noise filtering.

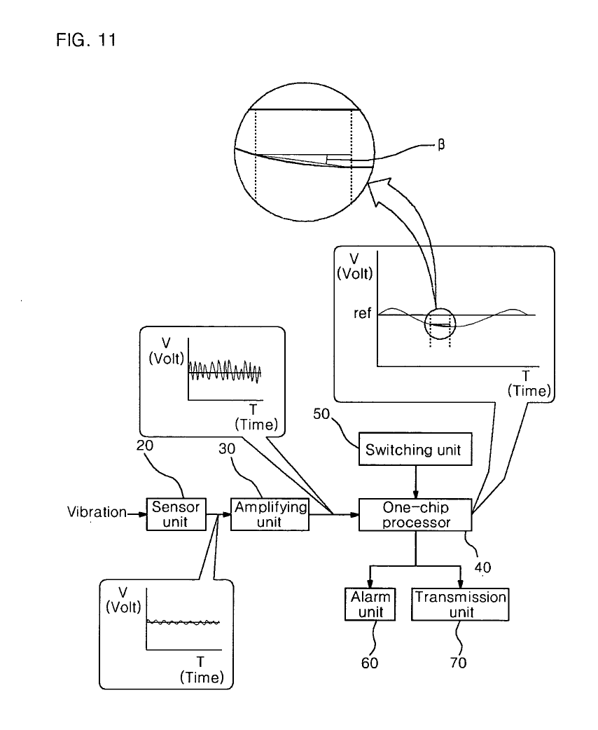

FIG. 11 is an explanatory diagram of the security alarm device in accordance with a fourth preferred embodiment of the present invention. In principle, the device is identical with that of FIG. 2 or the like, except that the one-chip processor finds the low-frequency signal generated when the door is opened using a different method.

With reference to FIG. 11, the present embodiment comprises the same steps in terms of detecting sound waves, amplifying and filtering processes, sound alarm and carrying out the transmission. However, it is distinctive since the one-chip processor employs a different method for recognizing the low-frequency signals as the change of pressure caused by the intrusion of the object from the outside.

More specifically, the above embodiment of the present invention takes an advantage of the characteristics of the gradient of the low-frequency waveforms generated by opening the door is relatively low. In other words, the gradient (β) of the voltage for the low-frequency waveforms, different from the waveforms of the general high-frequency noises, increases gradually.

Now referring to the graph on the right side of the one-chip processor, the device sounds the alarm for the waveforms inputted with the gradient below the designated level because it recognizes the waveforms to be the same with the waveform generated by opening the door. On the other hand, in case of the waveforms with the gradient above the designated level, the device recognizes the waveforms as just noises, and does not sound the alarm.

Preferably, the interval for measuring the gradient of the waveform is set on the basis of the voltage gradient between a designated time spaces having either the maximum value of the waveform or the minimum value of the waveform as one end.

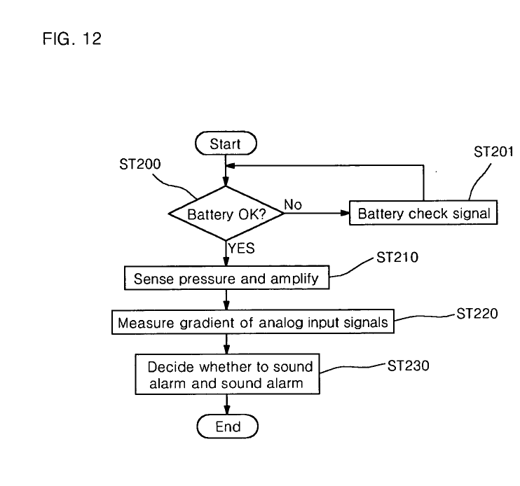

FIG. 12 is an explanatory diagram of the security alarm device in accordance with another preferred embodiment of FIG. 11.

The most of methods and components shown in FIG. 12 are pretty much identical to those of FIG. 4, except that the sampling values of the analog input signals (see Reference ST 120 in FIG. 4) were replaced with the gradients of the analog input signals (ST 220). Accordingly, confirming that the gradients smaller than the designated value are due to the change of pressure by opening or closing of the door, the device sounds the alarm.

The above-described method of sounding the alarm by measuring the gradient of the frequencies can be accomplished more accurately by designating the constant reference value (see Reference ST 130 in FIG. 6). More preferably, the reference value to be designated is the gradient of high frequencies that are regarded as noises generated prior to the normal operation of the security alarm device.

In addition, the digital frequency filter (see Reference 41 in FIG. 9) and the digital noise filter (see Reference 42 in FIG. 9) can be applied to increase the accuracy of the present invention, thereby filtering the low frequencies included in the noises.

Still as another method, sampling of the analog input signals and measuring the gradient of the analog signals can be applied concurrently or separately in order to increase or decrease the reliability of the security alarm method.

In case of the security alarm device to which sampling of the analog input signals and measuring the gradient of the analog signals are applied concurrently, the user can use the device more conveniently by adjusting the alarm method through the switching unit (see Reference 40 in FIG. 2 or 11). As for such device with two alarm methods, the user may have the device to sound the alarm if one of the two methods recognizes the intrusion of the unknown or unauthorized object from the outside, thereby increasing the reliability of the security alarm device.

Although the present invention has been described by way of exemplary embodiments, it should be understood that many changes and substitutions may be made by those skilled in the art without departing from the spirit and the scope of the present invention, which is defined by the appended claims.

The present invention provides the security alarm device for responding to the change of pressure characterized by employing the one-chip processor to make the overall size smaller.

The security alarm device of the present invention includes the designated filter configuration in order to recognize the intrusion of the unknown object from the outside more accurately, by easily recognizing the specific low frequencies that are generated when the intruder opens the door.

The security alarm device of the present invention can be affixed to a wide variety of objects including specific positions of inside doors to detect the intrusion of the object, or inside cellular phones or televisions. Therefore, the device does not require any additional equipment in the inside for the security, and also it may be affixed to anywhere the user wants. Especially, the security alarm device in accordance with the present invention may include an independent battery unit so that it may be attached to a toy or other portable items to make the device portable, therefore, the user can conveniently use the device anywhere.

According to the present invention, the security alarm device and the method thereof sounds the alarm to notify the intrusion of the object from the outside to the user in a remote place through the wire and/or wireless transmission system, helping the user to take corresponding actions for the intrusion.

Furthermore, the security alarm device of the present invention can be applied to a wide variety of usages including a means for sounding the alarm for turning the light off, the device being connected to the alarm signal in order to notify the intrusion of the object from the outside to the inhabitants in the inside, or a means for operating the tape recorder in accordance with the alarm signal against the intrusion in order to find out who the intruder is.

To notify the intrusion by using the designated alarm means, the alarm signal of the security alarm device of the present invention is preferably transmitted to a personal computer where a designated decision is made therefore, and the signal is transmitted to every alarm means.

In addition, if the inside doors is surrounded by the covering means like a wall, the device of the present invention can check whether there has been the intrusion regardless of the positions whether the device is installed.

In the meantime, the security alarm device of the present invention, contrary to the system in related art using the position sensors, is very useful for the alarm signal means because it senses only the low-frequency waveforms that are generated when the door opens. Therefore, in case that the security alarm device of the present invention is affixed to the designated position inside doors, the user can freely move within the designated space protected by the device.

1. A security device for responding to change of pressure, the device comprising:
a sensor unit for electrically detecting the change of indoor pressure generated by the intrusion of an object from the outside;
an amplifying unit for amplifying an electric signal corresponding to the change of indoor pressure detected by the sensor unit;
an one-chip processor for determining whether or not the electric signal transmitted from the amplifying unit is 1˜30 Hz frequencies that is caused by the intrusion of the object from the outside;
a switching unit for adjusting the operational state of the one-chip processor; and
an alarm unit for notifying the intrusion of the object to a user in case that the one-chip processor decides that the change of pressure is caused by the intrusion of the object from the outside.

2. The device of claim 1, wherein the sensor unit uses a condenser microphone.

3. The device of claim 1, further comprising a transmission unit for notifying the intrusion of the object from the outside detected by the one-chip processor based on the change of indoor pressure to the user by means of a wire and/or wireless transmission.

4. The device of claim 1, wherein the one-chip processor includes a low-pass filter that allows passage of a low frequency signal only, which is similar to the frequency generated by opening the door among other signals passed through the amplifying unit.

5. A portable security alarm apparatus for responding to change of pressure, the device comprising
a portable matter; and
a security alarm device which is placed in the portable matter, being placed anywhere the portable matter is placed;
the security alarm device comprising;
a sensor unit for electrically detecting the change of indoor pressure generated by the intrusion of an object from the outside;
an amplifying unit for amplifying an electric signal corresponding to the change of indoor pressure detected by the sensor unit;
an one-chip processor for determining whether or not the electric signal transmitted from the amplifying unit is caused by the intrusion of the object from the outside;
a switching unit for adjusting the operational state of the one-chip processor; and
an alarm unit for notifying the intrusion of the object to a user in case that the one-chip processor decides that the change of pressure is caused by the intrusion of the object from the outside.

6. A security alarm device for responding change of pressure, the device comprising:
a sensor unit for electrically detecting change of indoor pressure as the door opens;
an amplifying unit for amplifying the electric signal corresponding to the change of indoor pressure detected by the sensor unit;
a low-pass filter for passing a low electric signal only that is similar to the low frequency electric signal among other electric signals passed through the amplifying unit, being generated by change of indoor pressure owing to opening of door and/or window;
an one-chip processor for deciding whether or not the low frequency electric signal transmitted from the amplifying unit is the low frequency signal caused by opening;
a switching unit for adjusting the operational state of the one-chip processor;
an alarm unit for notifying the intrusion of the object to a user in case that the one-chip processor decides that the low frequency signal is caused by the intrusion of the object from the outside; and
a transmission unit for notifying the intrusion to the user via the wire and/or wireless telephone if the one-chip processor confirms that the low frequency signal is caused by the intrusion of the object from the outside.

7. The device of claim 6, wherein the one-chip processor further comprising a digital frequency filter for passing only similar frequencies to the frequency generated by opening the door more accurately among other low frequency electric signals that passed through the low-pass filter.

8. The device of claim 6, further comprising a digital noise filter for generating an on/off signal that makes the low frequency included in heavy noise to be properly ignored, being formed on a branched line after the amplifying unit.

9. The device of claim 6, wherein the switching unit adjusts the frequency sensitivity of the one-chip processor.

10. The device of claim 6, wherein the switching unit decides whether to send signals to the transmission unit or the alarm unit.

11. A security alarm method, comprising the steps of:
detecting change of indoor pressure through an electric signal of the sensor unit;
converting the electric signal detected by the sensor unit to an amplified analog signal;
a low-pass filtering the amplified analog signals to be passed by 1˜30 Hz frequencies;
converting the low-pass analog signals to digitalized sampling values by sampling the analog signals periodically; and
sounding alarm or warning the user in a remote place through the wire and/or wireless telephone if smaller sampling values than a reference are inputted for a certain period.

12. The method of claim 11, wherein the reference is optionally designated by a user.

13. The method of claim 11, wherein the reference takes a minimum value from at least two sampling values inputted in an early stage of the alarming step.

14. The method of claim 11, further comprising the step of band-pass filtering for passing a number of frequencies generated by opening the door immediately after the low-pass filtering step.

15. The method of claim 14, wherein a digital frequency filter is employed in the band-pass filtering.

16. The method of claim 14, wherein the band-pass filtering passes low frequencies to a broad range from 4 Hz to 12 Hz and/or from 14 Hz to 25 Hz.

17. The method of claim 11, further comprising the step of digital noise filtering for ignoring the electric signals at low frequencies in a heavy noise by making the on signal to select analog signals whose maximum value is smaller than the reference for a certain interval among other waveforms in a period of the analog signals outputted in the step of conversion.

18. A security alarm method, comprising the steps of:
detecting change of indoor pressure through an electric signal of the sensor unit;
converting the electric signal detected by the sensor unit to an amplified analog signal;
a low-pass filtering the amplified analog signals to be passed by a low bandwidth;
converting the low-pass analog signals to digitalized sampling values by sampling the analog signals periodically;
band-pass filtering 1˜30 Hz frequencies that are directly generated by opening the door; and
sounding alarm or warning the user in a remote place through the wire and/or wireless telephone if smaller sampling values than the reference are inputted for a certain period.

19. A security alarm method, comprising the steps of:
detecting change of indoor pressure through an electric signal of the sensor unit;
converting the electric signal detected by the sensor unit to an amplified analog signal;
a low-pass filtering the amplified analog signals to be passed by a low bandwidth;
measuring a gradient of the low-pass analog signals; and
sounding alarm or warning the user in a remote place through the wire and/or wireless telephone if smaller sampling values than the reference are inputted for a certain period.

20. The method of claim 19, wherein the gradient is measured in an interval having either the maximum value of the waveform or the minimum value of the waveform as one end.
